(19) United States
(12) Patent Application Publication
(10) Pub. No.: US 2013/0248513 A1
(43) Pub. Date: Sep. 26, 2013

(54) HEATER ELEMENT FOR VEHICLE

(71) Applicant: TOYODA GOSEI CO., LTD., Kiyosu-shi (JP)

(72) Inventor: Bunpei MORITA, Kiyosu-shi (JP)

(73) Assignee: TOYODA GOSEI CO., LTD., Kiyosu-shi (JP)

(21) Appl. No.: 13/792,821

(22) Filed: Mar. 11, 2013

(30) Foreign Application Priority Data
Mar. 21, 2012 (JP) 2012-063943

(51) Int. Cl. H05B 3/02

(52) U.S. Cl. CPC H05B 3/02
USPC 219/535

(57) ABSTRACT

A heater element for vehicle includes: a non-conductive base material; a conductive heat conduction sheet laminated on the base material; a heating wire which is arranged between the base material and the heat conduction sheet and which generates heat by energization; and an insulation layer which electrically insulates the heating wire from the heat conduction sheet. The heat conduction sheet is separated in an extending direction of the heating wire.

### BACKGROUND

1. Technical Field

The invention relates to a heater element for a vehicle.

2. Background Art

As a heater element mounted on a vehicle, Patent Document 1 discloses a heater element provided in a steering wheel.

The heater element disclosed in Patent Document 1 includes a heating wire, an inner cover provided on an outer side of the heating wire, an outer cover provided on an outer side of the inner cover, and a heat conduction sheet (heat-equalizing foil) welded on the outer cover and made of aluminum. In the heater element, electrical insulation between the heating wire and the heat conduction sheet, which are conductors, is secured by the insulation layer such as the inner cover or outer cover.

Patent Document 1: JP-Y2-63-11029

### SUMMARY

When the insulation layer is damaged at two or more portions thereof, the current that should normally flow through the heating wire is allowed to flow to the heat conduction sheet between the damaged portions. Thereby, a resistance value of the entire heating wire is reduced, and an amount of heat generation of the heating wire increases.

The present invention has been made in view of the above-described circumstances, and an object thereof is to provide a heater element for vehicle which can suppress an increase in an amount of heat generation of a heating wire due to a damage of an insulation layer.

In a first aspect of the invention, a heater element for vehicle includes: a non-conductive base material; a conductive heat conduction sheet laminated on the base material; a heating wire which is arranged between the base material and the heat conduction sheet and which generates heat by energization; and an insulation layer which electrically insulates the heating wire from the heat conduction sheet. The heat conduction sheet is separated in an extending direction of the heating wire.

According to the first aspect, the heat conduction sheet is separated in the extending direction of the heating wire, whereby the conduction of electricity does not occur between separated heat conduction sheet parts. Therefore, even when the insulation layer is damaged below the different heat conduction sheet parts, the current of the heating wire does not flow between the corresponding heat conduction sheet parts. Hence, a resistance value of the whole heating wire does not change, and an amount of heat generation of the heating wire due to the damage of the insulation layer does not increase.

Even when the insulation layer is damaged at two or more portions below one heat conduction sheet part, the current flowing through the heating wire flows through the one heat conduction sheet part. Hence, regarding the whole heat conduction sheet separated into the plurality of heat conduction sheet parts, the current of the heating wire flows to only a part of the heat conduction sheet, and a distance of the heating wire at which a short circuit occurs is relatively small. Thus, it is possible to suppress a decrease in the resistance value of the whole heating wire. Thereby, it is possible to suppress an increase in an amount of heat generation of the heating wire due to the damage of the insulation layer.

For the above reasons, it is possible to suppress an increase in an amount of heat generation of the heating wire due to the damage of the insulation layer.

In a second aspect of the invention, the heat conduction sheet is separated by a slit extending in a direction intersecting with the extending direction of the heating wire.

According to the second aspect, since the heat conduction sheet can be separated simply by forming the slits at the heat conduction sheet, it is possible to separate the heat conduction sheet by the simple configuration.

The insulation layer may cover an outer periphery of the heating wire in a third aspect of the invention, and may be formed on a surface of the heat conduction sheet facing the base material in a fourth aspect of the invention.

In a fifth aspect of the invention, the heater element includes a heater element provided in a steering wheel.

A driver always touches the steering wheel provided in a vehicle interior during the vehicle traveling. Thus, if an amount of heat generation of the heating wire increases when the heater element is provided in the steering wheel, the driver may feel uncomfortable for a relatively long time. In the fifth aspect, it is possible to suppress the increase in the amount of heat generation of the heating wire in the heater element provided in the steering wheel. Hence, it is possible to suppress the problem that the driver feels uncomfortable for a relatively long time.

### BRIEF DESCRIPTION OF THE DRAWINGS

FIG. 1 is a side view of a steering wheel with a heater element for vehicle according to an illustrative embodiment of the invention;

FIG. 2 shows the steering wheel seen from an arrow C in FIG. 1;

FIG. 3 is a partial sectional view (partial sectional view taken along a line 3-3 of FIG. 4) of the heater element of the illustrative embodiment;

FIG. 4 is a plan view of the heater element of the illustrative embodiment;

FIG. 5 is a schematic diagram showing a separated state of a heat conduction sheet of the illustrative embodiment;

FIG. 6 is a partial sectional view (partial sectional view taken along an extending direction of a heating wire) of a related-art heater element;

FIG. 7 is a partial sectional view (partial sectional view taken along an extending direction of a heating wire) of the heater element of the illustrative embodiment;

FIG. 8 is a partial sectional view (partial sectional view taken along an extending direction of a heating wire) of the heater element of the illustrative embodiment; and

FIG. 9 is a partial sectional view (partial sectional view taken along an extending direction of a heating wire) of a heater element according to a modified embodiment of the illustrative embodiment.

### DETAILED DESCRIPTION

Hereinafter, an illustrative embodiment of a heater element for vehicle of the invention will be described with reference to FIGS. 1 to 8.

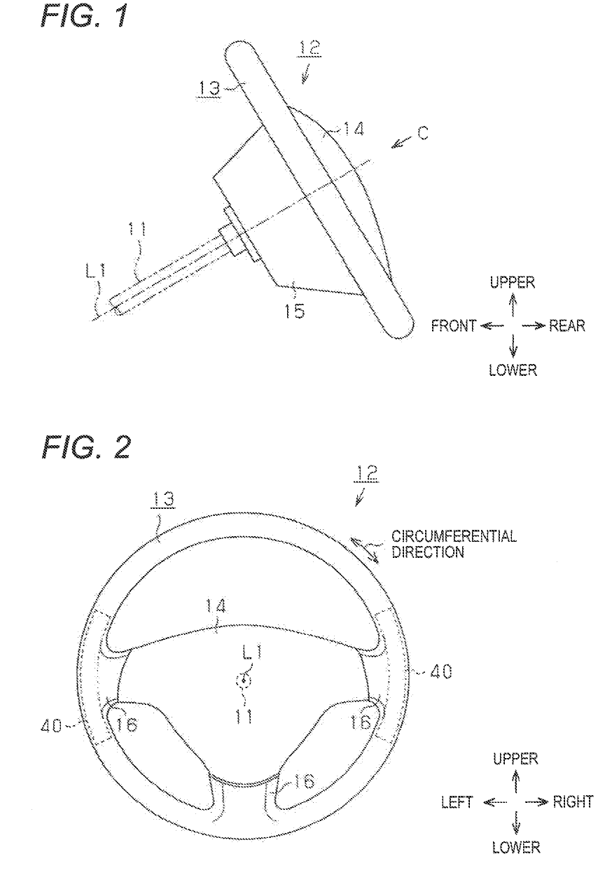

As shown in FIGS. 1 and 2, a steering shaft 11 that rotates about a rotational axis line L1 is arranged at the front (the left in FIG. 1) of a driver seat of a vehicle with being upwards inclined toward the driver seat (the right in FIG. 1). A steering wheel 12 is rotatably integrated with a rear end portion of the steering shaft 11.

The steering wheel 12 includes a rim part (which is also referred to as a handle part or ring part) 13, a pad part 14 and spoke parts 16 (refer to FIG. 2). The rim part 13 is gripped and rotation-operated (steered) by a driver, and has a substantially circular ring shape about the rotational axis line L1 (refer to FIG. 2).

The pad part 14 is disposed in a space surrounded by the rim part 13. A front side part of the pad part 14 includes a lower cover 15 (refer to FIG. 1). The plurality of spoke parts 16 (three spoke parts, in this illustrative embodiment) is provided between the rim part 13 and the pad part 14.

In order to specify a circumferential position of the rim part 13 that is rotation-operated (steered), the ‘upper’, the ‘lower’, the ‘left’ and the ‘right’ are defined based on a state (neutral state) where a vehicle travels straight, in this illustrative embodiment.

In the rim part 13, the spoke parts 16 and the pad part 14 of the steering wheel 12, core bars made of iron, aluminum, magnesium or alloys thereof are arranged, respectively. Among the core bars, a core bar positioned in the rim part 13 configures a framework of the rim part 13 and has a substantially circular ring shape as viewed from the driver side. The core bar in the rim part 13 is referred to as a rim part core bar 20.

As shown with the broken line in FIG. 2, heater elements 40 are incorporated in left and right side parts that most of drivers grip with respect to the circumferential direction of the rim part 13. More specifically, the heater element 40 is adhered so that it covers the rim part core bar 20.

Hereinafter, a structure of the heater element 40 of this illustrative embodiment is described.

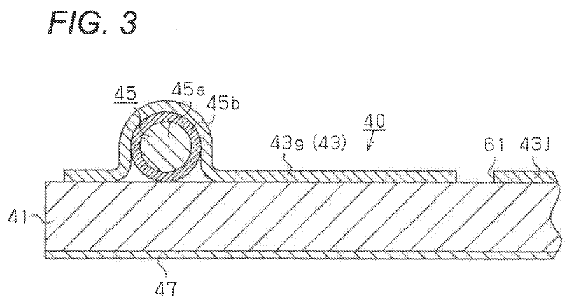

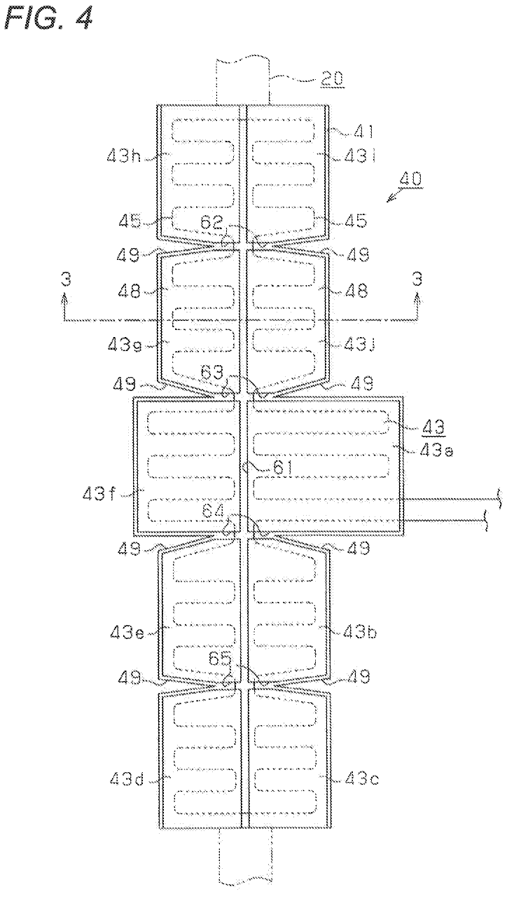

FIG. 3 shows a sectional structure of the heater element 40, and FIG. 4 is a plan view of the heater element 40 at a developed state.

As shown in FIGS. 3 and 4, the heater element 40 includes a heat insulation sheet 41, a heat conduction sheet 43, a heat generation member 45 and an adhesive layer 47. In this illustrative embodiment, the heat conduction sheet 43 includes a plurality of heat insulation sheet parts, more specifically, first to tenth heat conduction sheet parts 43a to 43j.

As shown in FIG. 3, the heat insulation sheet 41 is made of a non-conductive insulation material having flexibility, and has a plate shape of a uniform thickness (2 to 3 mm, in this illustrative embodiment). As the insulation material, an elastic and flexible resin material such as urethane and rubber may be preferably used. In the meantime, the heat insulation sheet 41 preferably includes a foamed member, from a standpoint of an increase in heat insulation properties. Thus, in this illustrative embodiment, the heat insulation sheet 41 is made of foamed urethane. The heat insulation sheet 41 serves as the base material.

The heat conduction sheet 43 is provided so as to rapidly spread the heat generated from the heat generation member 45. The heat conduction sheet 43 is thinner than the heat insulation sheet 41, and is made of a material having a high thermal conductivity. Since the heat conduction sheet 43 is bent along the rim part core bar 20 as well as the heat insulation sheet 41, the heat conduction sheet is preferably thin. In this illustrative embodiment, the heat conduction sheet 32 is made of a conductive aluminum foil. The heat conduction sheet 43 is laminated on the heat insulation sheet 41, and is fixed to the heat insulation sheet 41 by a fixing means such as adhesion.

The heat generation member 45 includes: a hating wire 45a arranged between the heat insulation sheet 41 and the heat conduction sheet 43 and generates heat by energization and an insulation layer 45b which electrically insulates between the heating wire 45a and the heat conduction sheet 43.

The heating wire 45a is sufficient to generate the heat only by the energization, and is made of a wire rod material having high electric resistance and generating heat by energization. Also, as shown in FIG. 4, the heat generation member 45 (heating wire 45a) is repeatedly bent and arranged so that it forms a waveform in a longitudinal direction of the heater element 40 (in the upper-lower direction in FIG. 4).

The insulation layer 45b is made of a non-conductive resin and the like and covers an outer periphery of the heating wire 45a.

The adhesive layer 47 has a uniform thickness on a whole surface of the heat insulation sheet 41 opposite to the heat generation member 45.

As shown in FIG. 4, the heater element 40 has a long shape at a developed state. The heater element 40 has a pair of opposing edge parts 48 extending in a longitudinal direction with opposing each other. In the heater element 40, the heat insulation sheet 41 and the heat conduction sheet 43 include cut portions 49 extending from a plurality of portions of each opposing edge part 48 toward the other opposing edge part 48. Each of the cut portions 49 has a width narrower as the distance from the opposing edge part 48 increases. The cut portions 49 can avoid a wrinkle in the heater element 40 in a state where the heater element 40 is adhered to the rim part core bar 20.

The heat insulation sheet 43 laminated on the heat insulation sheet 41 is provided with a first slit 61 formed in the longitudinal direction of the heater element 40 around a center of the heater element 40 and second to fifth slits 62 to 65 formed in a direction perpendicular to the longitudinal direction of the heater element 40. The second to fifth slits 62 to 65 are provided between the cut portions 49 facing each other, and formation intervals of the second to fifth slits 62 to 65 in the longitudinal direction of the heater element 40 are substantially equal.

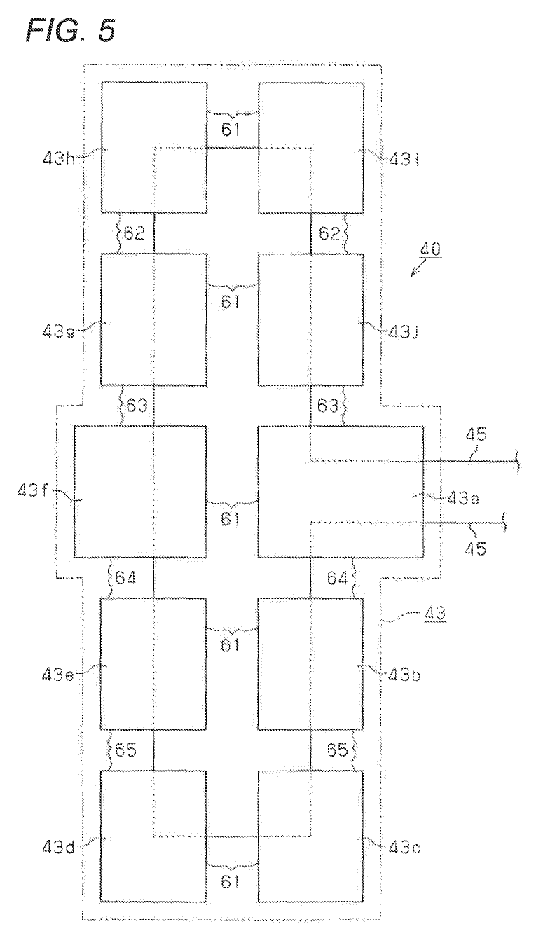

As schematically shown in FIG. 5, the heat conduction sheet 43 is separated into the ten heat conduction sheet parts, i.e., the first to tenth heat conduction sheet parts 43a to 43j by the first to fifth slits 61 to 65. More specifically, the heat conduction sheet 43 is separated in an extending direction of the heat generation member 45 (heating wire 45a) by the slits intersecting with the heat generation member 45 (heating wire 45a), i.e., the slits (first to fifth slits 61 to 65) extending in a direction intersecting with the extending direction of the heat generation member 45 (heating wire 45a). Specifically, the first heat conduction sheet part 43a is a heat conduction sheet part from which the heat generation member 45 is taken out to the outside. Based on the first heat conduction sheet part 43a, the second heat conduction sheet part 43b, the third heat conduction sheet part 43c, the fourth heat conduction sheet part 43d, the fifth heat conduction sheet part 43e, the sixth heat conduction sheet part 43f, the seventh heat conduction sheet part 43g, the eighth heat conduction sheet part 43h, the ninth heat conduction sheet part 43i and the tenth heat conduction sheet part 43j are provided in a clockwise direction toward the extending direction of the heat generation member 45.

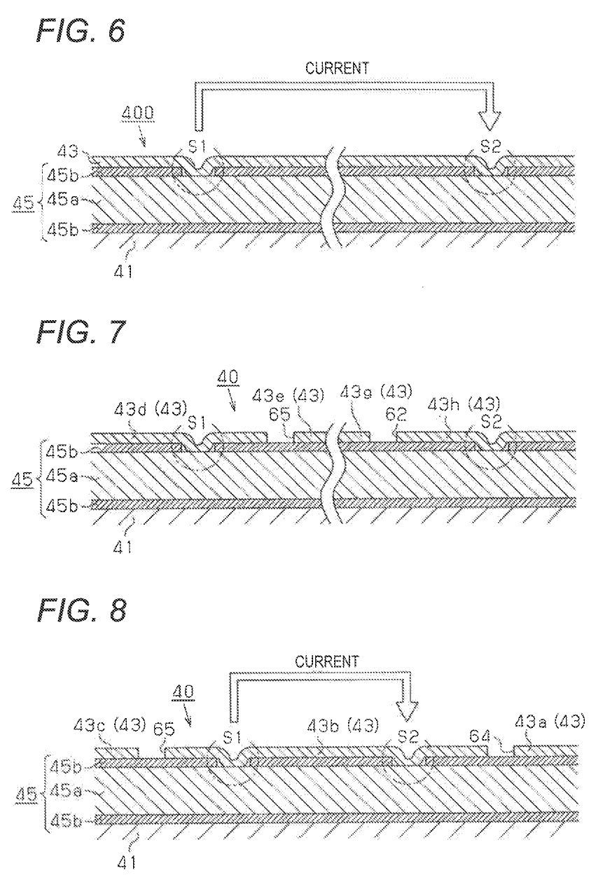

Next, operations of the heater element 40 of this illustrative embodiment in which the heat conduction sheet 43 is separated into the plurality of heat conduction sheet parts are described with reference to FIGS. 6 to 8. Meanwhile, a heater element 400 shown in FIG. 6 is a heater element in which the heat conduction sheet 43 is not separated, contrary to the heater element 40 of this illustrative embodiment.

As shown in FIG. 6, in the heater element 400 in which the heat conduction sheet 43 is not separated, when the insulation layer 45b is damaged at two portions and the heat insulation sheet 43 contacts the heating wire 45a at the first damaged part S1 and the second damaged portion S2, the current that should normally flow through the heating wire 45a is allowed to flow to the heat conduction sheet 43 between the first and second damaged portions S1, S2. When a part of the hearing wire 45a is shorted by the heat conduction sheet 43 accordingly, a resistance value of the whole heating wire 45a is reduced, so that an amount of heat generation of the heating wire 45a may be increased. Such increase in the amount of heat generation of the heating wire 45a may be caused when the insulation layer 45b is damaged at two or more portions.

In contrast, according to the heater element 40 of this illustrative embodiment, the heat conduction sheet 43 is separated in the extending direction of the heating wire 45a, as described above. The conduction of electricity does not occur between the separated heat conduction sheet parts.

When the insulation layer 45b is damaged below the different heat conduction sheet parts, for example as shown in FIG. 7, the insulation layer 45b is damaged below the fourth heat conduction sheet part 43d, and the heat conduction sheet 43 contacts the heating wire 45a at the first damaged portion S1. Also, when the insulation layer 45b is also damaged below the eighth heat conduction sheet part 43h, the heat conduction sheet 43 contacts the heating wire 45a at the second damaged portion S2. Even in this case, the current of the heating wire 45a does not flow between the fourth heat conduction sheet part 43d and the eighth heat conduction sheet part 43h because the heat conduction sheet 43 is separated. Therefore, the resistance value of the whole heating wire 45a does not change, and the increase in the amount of heat generation of the heating wire 45a due to the damage of the insulation layer 45b is not caused. Also, even when the insulation layer 45b is damaged at one portion below each of three or more heat conduction sheet parts, the current of the heating wire 45a does not flow between the heat conduction sheet parts, so that the resistance value of the whole heating wire 45a does not change, and the increase in the amount of heat generation of the heating wire 45a due to the damage of the insulation layer 45b is not caused.

When the insulation layer 45b is damaged at two or more portions below the one heat conduction sheet part, for example as shown in FIG. 8, when the insulation layer 45b is damaged at two portions below the second heat conduction sheet part 43b and the heat conduction sheet 43 contacts the heating wire 43a at the first damaged portion S1 and the second damaged portion S2, the current flowing through the heating wire 45a flows through the one heat conduction sheet part only, i.e., the second heat conduction sheet part 43b. Hence, with respect to the whole heat conduction sheet 43 separated into the plurality of heat conduction sheet parts, the current of the heating wire 45a flows to only a part of the heat conduction sheet, and a distance of the heating wire 45a at which a short circuit occurs is relatively small. Thus, it is possible to suppress the decrease in the resistance value of the whole heating wire 45a. Thereby, it is possible to suppress the increase in the amount of heat generation of the heating wire 45a due to the damage of the insulation layer 45b. When the insulation layer 45b is damaged at two or more portions below the one heat conduction sheet part (for example, when the insulation layer 45b is damaged at three portions below the second heat conduction sheet part 43b), the current of the heating wire 45a flows between the two damaged portions having the longest distance at which a short circuit occurs. Therefore, even when the insulation layer 45b is damaged at three or more portions below the one heat conduction sheet part, it is possible to realize the substantially same operational effects as the case where the insulation layer 45b is damaged at two portions below the one heat conduction sheet part.

The driver always touches the steering wheel 12 provided in a vehicle interior during the vehicle traveling. Thus, if an amount of heat generation of the heating wire 45a increases when the heater element is provided in the steering wheel 12, the driver may feel uncomfortable for a relatively long time. According to this illustrative embodiment, it is possible to suppress the increase in the amount of heat generation of the heating wire 45a in the heater element 40 provided in the steering wheel 12. Hence, it is possible to suppress the problem that the driver feels uncomfortable for a relatively long time.

As described above, according to this illustrative embodiment, the following effects are realized.

(1) The heater element 40 for vehicle includes the insulation layer 45b that electrically insulates the heating wire 45a from the heat conduction sheet 43. The heat conduction sheet 43 is separated in the extending direction of the heating wire 45a. Therefore, even when the insulation layer 45b is damaged below the different heat conduction sheet parts, the current of the heating wire 45a does not flow between the different heat conduction sheet parts. Hence, the resistance value of the whole heating wire 45a does not change, and the amount of heat generation of the heating wire 45a due to the damage of the insulation layer 45b does not increase.

Even when the insulation layer 45b is damaged at two or more portions below one heat conduction sheet part, the current flowing through the heating wire 45a just flows through the one heat conduction sheet part. Hence, it the decrease in the resistance value of the whole heating wire 45a can be suppressed. Thereby, it is possible to suppress the increase in the amount of heat generation of the heating wire 45a due to the damage of the insulation layer 45b.

According to this illustrative embodiment, it is possible to suppress the increase in the amount of heat generation of the heating wire 45a due to the damage of the insulation layer 45b.

(2) The heat conduction sheet 43 is separated by the slits (first to fifth slits 61 to 65) extending in the direction intersecting with the extending direction of the heating wire 45a. Therefore, since the heat conduction sheet 43 can be separated simply by forming the slits at the heat conduction sheet 43, it is possible to separate the heat conduction sheet 43 by the simple configuration.

(3) The heat conduction sheet 43 of the heater element 40 provided in the steering wheel 12 is separated. Therefore, it is possible to suppress the driver's uncomfortable feeling for a relatively long time due to the increase in the amount of heat generation of the heating wire 45a.

The invention can be also implemented by other illustrative embodiments described below.

Although the heat conduct sheet 43 is separated into the ten sheet parts, the number of separated sheet parts may be appropriately changed.

The heat conduction sheet 43 is separated by the slits provided in the heat conduction sheet 43. As another embodiment, a plurality of heat conduction sheets 43 may be prepared in advance, and the heat conduction sheets 43 may be provided to be spaced from one another on the heat insulation sheet 41, so that the heat conduction sheets 43 are separated in the extending direction of the heating wire 45a.

As the base material on which the heat conduction sheet 43 is laminated, the material other than the heat insulation sheet 41 may be applied. For example, the sheet configuring the adhesive layer 47 may be used as the base material.

The insulation layer 45b is provided to cover the outer periphery of the heating wire 45a. However, other arrangement may be implemented so long as the insulation layer 45b electrically insulates the heating wire 45a from the heat conduction sheet 43.

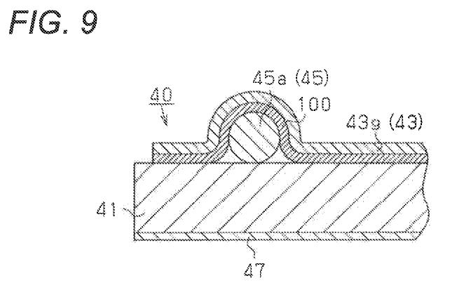

For example, as shown in FIG. 9, the insulation layer 45b may be omitted from the heat generation member 45, and the heat generation member 45 may include the heating wire 45a without the insulating layer 45b. Then, an insulation layer 100 having the equivalent function to the insulation layer 45b may be formed on a surface of the heat conduction sheet 43 facing the heat insulation sheet 41 (the base material). Also in this configuration, it is possible to suppress the increase in the amount of heat generation of the heating wire 45a due to the damage of the insulation layer 100.

The heat conduction sheet 43 may be a member made of a material different from the aluminum foil so long as the member can rapidly spread the heat generated by the heat generation member 45. For example, the heat conduction sheet 43 may be made of a copper foil.

The heat generation member 45 may be a member different from the heating wire 45a so long as the member can generate the heat by the energization. For example, a member having a resistance layer formed on an insulation sheet may be used as the heat generation member 45.

The heat generation member 45 may be arranged between the heat insulation sheet 41 and the heat conduction sheet 43, differently from the above illustrative embodiment. For example, the heat generation member 45 may be repeatedly bent and arranged so that it forms a waveform in a width direction of the heater element 40.

The adhesive layer 47 may be omitted from the heater element 40. In this case, the heater element 40 may be adhered to the rim part core bar 20 by an adhesive, for example.

In the above illustrative embodiment, the second to fifth slits 62 to 65 are provided between the cut portions 49 facing each other. However, the slits may be provided at other positions, so long as the slits are formed in the heat conduction sheet 43 in a direction intersecting with the extending direction of the heating wire 45a.

The cut portions 49 may have a different shape from the above illustrative embodiment. Also, the cut portions 49 may be omitted.

The heater element of the invention is not limited to the steering wheel 12 and may be applied to other heater elements for vehicle such as shift knob, seat, etc.

What is claimed is:

1. A heater element for vehicle comprising:
a non-conductive base material;
a conductive heat conduction sheet laminated on the base material;
a heating wire which is arranged between the base material and the heat conduction sheet and which generates heat by energization; and
an insulation layer which electrically insulates the heating wire from the heat conduction sheet,
wherein the heat conduction sheet is separated in an extending direction of the heating wire.

2. The heater element for vehicle according to claim 1, wherein the heat conduction sheet is separated by a slit extending in a direction intersecting with the extending direction of the heating wire.

3. The heater element for vehicle according to claim 1, wherein the insulation layer covers an outer periphery of the heating wire.

4. The heater element for vehicle according to claim 1, wherein the insulation layer is formed on a surface of the heat conduction sheet facing the base material.

5. The heater element for vehicle according to claim 1, wherein the heater element comprises a heater element provided in a steering wheel.
